(19) United States
(12) Patent Application Publication
(10) Pub. No.: US 2020/0271170 A1
(43) Pub. Date: Aug. 27, 2020

(54) INTEGRATED DRIVELINE SLIP CLUTCH SYSTEM FOR LARGE SQUARE BALER

(71) Applicant: AGCO Corporation, Duluth, GA (US)

(72) Inventors: Kevin M. Tacke, Oskaloosa, IA (US); Thomas G. Schrag, Hesston, KS (US); Maynard M. Herron, Hesston, KS (US)

(21) Appl. No.: 16/063,953

(22) PCT Filed: Dec. 21, 2016
(86) PCT No.: PCT/US2016/068079

§ 371 Date: Jun. 19, 2018

Related U.S. Application Data
(60) Provisional application No. 62/272,536, filed on Dec. 29, 2015.

(51) Int. Cl. F16D 7/00; F16D 43/04; F16D 31/00; F16D 28/00; F16D 48/06; A01F 15/04; A01F 15/08

(52) U.S. Cl. CPC F16D 7/00; F16D 43/04; F16D 31/00; F16D 28/00; F16D 2500/111; A01F 15/04; A01F 15/08; F16D 2500/10437; F16D 2500/1026; F16D 48/066

(57) ABSTRACT

An integrated driveline (136, 236, 336, 36, 436) slip clutch (154, 254, 354, 454) system for a large square baler (28) for controlling a transfer of power from a tractor (26) to the baler (28). The clutch (254) system includes a slip clutch (154, 254, 354, 454) having a number of clutch plates (388). The slip clutch (154, 254, 354, 454) is moveable between a disengaged relationship in which no power is transferred from a driveline (136, 236, 336, 36, 436) to a gearbox (140, 240, 340, 40, 440), and one or more engaged relationships in which amounts of power are transferred from the driveline (136, 236, 336, 36, 436) to the gearbox (140, 240, 340, 40, 440). Movement of the slip clutch (154, 254, 354, 454) between engagement relationships may be controlled mechanically (by, e.g., centrifugal force) or electronically. For electronic control, a controller receives input data from sensors (504) concerning operation of the baler (28), and controls a valve to introduce or remove hydraulic fluid to or from a clutch cylinder (276, 376, 476) or a double acting cylinder (496) in accordance with a pressure control profile which ramps hydraulic pressure through levels to achieve the engagement relationships.

### CROSS REFERENCE TO RELATED APPLICATION

This application claims the benefit of U.S. Provisional Application No. 62/272,536 filed Dec. 29, 2015, which is hereby incorporated by reference in its entirety.

### BACKGROUND

### Field of Invention

The present invention relates to systems for controlling the operation of balers. More specifically, the present invention concerns a system for controlling a transfer of power from a tractor to a baler.

### Description of Related Art

Large square balers are used in the agricultural industry to create large substantially rectangular bales of crop material by moving over crop windrows to collect loose crop material, compress it, and form it into bales that are then tied and ejected. To that end, a baler is typically mechanically coupled with a tractor, and a power take-off (PTO) mechanism transfers power from the tractor engine to drive the baler operation. The baler picks up the loose crop material and moves it into a baling chamber where a reciprocating plunger compresses the crop material into a growing bale. Once the bale reaches a predetermined length it is tied and ejected through the rear of the baler. The process then continues to create the next bale.

Large square balers typically have flywheels to smooth operation, and starting a large square baler requires substantial amount of torque from the PTO to overcome the resting inertia of the flywheel and other components. High density large square balers require relatively large flywheels, and the higher inertia results in higher starting torques than some tractor PTO clutches can reliably provide for baler startup, and can shorten clutch longevity. The required torque is further increased during restarting if the reciprocating plunger is initially positioned against a bale in the baling chamber, and the additional load of the bale as the reciprocating plunger attempts to push past its “rear-dead-center” position can result in stalling the tractor engine or disengaging the PTO. One solution has been to use a hydraulic drive to assist with baler startup, but the effectiveness of this solution is limited.

This background discussion is intended to provide information related to the present invention which is not necessarily prior art.

### BRIEF SUMMARY OF INVENTION

Embodiments of the present invention solve the above-described and other problems and limitations by providing a system for controlling a transfer of power from a tractor to a baler. More specifically, the present invention provides an integrated driveline slip clutch for a large square baler by incorporating an engage/disengage slip clutch and a clutch control into the main driveline so that startup of the baler is achieved at a controlled rate. Further, the slip clutch may continue to provide driveline and PTO protection by limiting the amount of torque transmitted to the baler during normal baler operation.

According to a first aspect of the present invention, a baler broadly includes a plunger reciprocal within a baling chamber, a driveline configured to receive mechanical power from a tractor, a flywheel configured to smooth the received mechanical power, a gearbox configured to condition the smoothed mechanical power to drive the reciprocating plunger in the baling chamber, and an integrated driveline clutch system for controlling the transfer of power from the tractor to the baler. The integrated driveline clutch system comprises a slip clutch having a plurality of clutch plates. The slip clutch is configured to be moveable between a disengaged relationship in which no power is transferred from the driveline to the gearbox, and one or more engaged relationships in each of which an amount of power is transferred from the driveline to the gearbox.

Various implementations of the foregoing embodiments may include any one or more of the following additional features.

Movement of the slip clutch between the disengaged relationship and the one or more engaged relationships may be controlled mechanically. For example, movement of the slip clutch between the disengaged relationship and the one or more engaged relationships may be controlled by a plurality of weights attached to a plurality of lever arms spaced around a perimeter of the plurality of clutch plates, and a centrifugal force provided by the turning driveshaft may cause the plurality of weights to apply via the plurality of lever arms a compressive force to the plurality of clutch plates and thereby move the slip clutch into the one or more engaged relationships. The slip clutch may further include a plurality of springs interposed between the plurality of lever arms and the plurality of clutch plates, and the springs may be configured to control the compressive force applied by the plurality of lever arms to the plurality of clutch plates.

Alternatively, movement of the slip clutch between the disengaged relationship and the one or more engaged relationships may be controlled electronically. For example, movement of the slip clutch between the disengaged relationship and the one or more engaged relationships may be controlled by an electronically controlled valve configured to introduce and remove a hydraulic fluid so as to move a clutch cylinder to act on the plurality of clutch plates and thereby move the slip clutch into the one or more engaged relationships. The system may further include an electronic controller configured to receive one or more input data signals from one or more sensors concerning operation of the baler, and based on the one or more input data signals, control operation of the electronically controlled valve. The electronic controller may be configured to cause the electronically controlled valve to introduce and remove the hydraulic fluid at a controlled rate to achieve the one or more engaged relationships, and/or the electronic controller may be configured to follow a pressure control profile in which the electronic controller causes the amount of hydraulic fluid to be ramped at the controlled rate through one or more levels to achieve the one or more engaged relationships. The slip clutch may further include a plurality of springs interposed between the clutch cylinder and the plurality of clutch plates, and the springs may be configured to control the compressive force applied by the clutch cylinder to the plurality of clutch plates.

The system may further include a gearbox shaft having a central passage in fluid communication with the clutch cylinder, wherein the hydraulic fluid is introduced into and removed from the clutch cylinder via the central passage in the gearbox shaft. Alternatively, the system may further include a double acting cylinder configured to move the clutch cylinder, wherein introduction of the hydraulic fluid into the double acting cylinder moves the clutch cylinder to apply a compressive force to the plurality of clutch plates and thereby move the slip clutch into the one or more engaged relationships. The system may further include a lever arm attached at a first end by a yoke to the clutch cylinder, and attached at a second end to the double acting cylinder, and the lever arm may be configured to transmit movement of the double acting cylinder via the yoke to the clutch cylinder.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a cross-sectional elevation view of an exemplary baling system which may incorporate an embodiment of the present invention;

FIG. 2 is a fragmentary isometric view of a first embodiment of an integrated driveline slip clutch system for a large square baler component of the baling system of FIG. 1;

FIG. 3 is a cross-sectional fragmentary elevation view of the integrated driveline slip clutch system of FIG. 2;

FIG. 4 is a fragmentary perspective view of a second embodiment of the integrated driveline slip clutch system for the large square baler component of the baling system of FIG. 1;

FIG. 5 is a cross-sectional fragmentary elevation view of the integrated driveline slip clutch system of FIG. 4;

FIG. 6 is a fluid circuit diagram for an exemplary control system for the controlling operation of the integrated driveline slip clutch system of FIGS. 4 and 5;

FIG. 7 is a fragmentary elevation view of a third embodiment of the integrated driveline slip clutch system for the large square baler component of the baling system of FIG. 1;

FIG. 8 is a cross-sectional fragmentary elevation view of the integrated driveline slip clutch system of FIG. 7;

FIG. 9 is a fragmentary elevation view of a fourth embodiment of the integrated driveline slip clutch system for the large square baler component of the baling system of FIG. 1;

FIG. 10 is a cross-sectional fragmentary elevation view of the integrated driveline slip clutch system of FIG. 9;

FIG. 11 is a fluid circuit diagram for an exemplary control system for controlling operation of the integrated driveline slip clutch system of FIGS. 9 and 10;

FIG. 12 is a cross-sectional fragmentary elevation view of an alternative implementation of the fourth embodiment of the integrated driveline slip clutch system shown in FIGS. 9 and 10;

FIG. 13 is diagrammatical representation of an exemplary embodiment of an electronic controller configured to control operation of the integrated driveline slip clutch system; and

FIG. 14 is an exemplary clutch engagement pressure control profile which may be followed by one or more of the embodiments of the integrated driveline slip clutch system.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, the present invention provides a system for controlling a transfer of power from a tractor to a baler. More specifically, the present invention provides an integrated driveline slip clutch system for a large square baler by incorporating an engage/disengage slip clutch and a clutch control into the main driveline so that startup of the baler is achieved at a controlled rate. Further, the slip clutch may continue to provide driveline and PTO protection by limiting the amount of torque transmitted to the baler during normal baler operation.

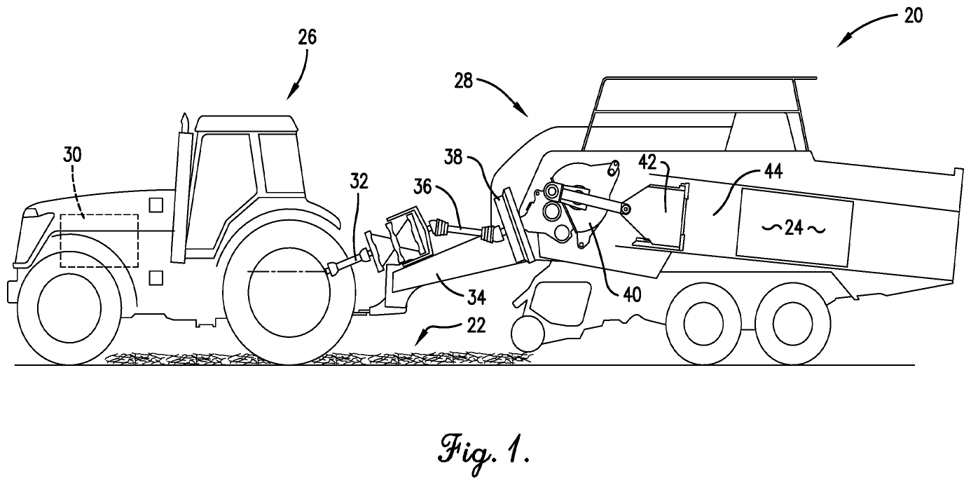

Referring to FIG. 1, an embodiment of an exemplary baling system 20 may be configured to receive loose crop material 22 and compress it into a growing bale 24 to produce a finished bale. The baling system 20 may broadly comprise a tractor 26 and a baler 28. The tractor 26 may include an engine 30 configured to drive the tractor 26, and a PTO 32 configured to transfer mechanical power from the engine 30 to the baler 28 or other connected machinery. The baler 28 may broadly comprise a frame 34 mechanically coupled with the tractor 26, a driveline 36 configured to receive mechanical power from the PTO 32, a flywheel 38 configured to smooth the received mechanical power, and a gearbox 40 configured to condition the smoothed mechanical power to drive, e.g., a reciprocating plunger 42 in a baling chamber 44.

The baling chamber 44 may be configured to receive the loose crop material 22 so that it can be compressed by the plunger 42 into the bale 24. The baling chamber 44 may be substantially rectangular in shape to facilitate the compression and forming process. The plunger 42 may be configured to compress the loose crop material 22 by moving within the baling chamber 44 in a reciprocating manner. More specifically, the plunger 42 may repeatedly extend into the forming chamber 44 to compress the loose crop material 22 that is already present therein, and then retract to allow additional loose crop material 22 to enter the forming chamber 44 for compress1On.

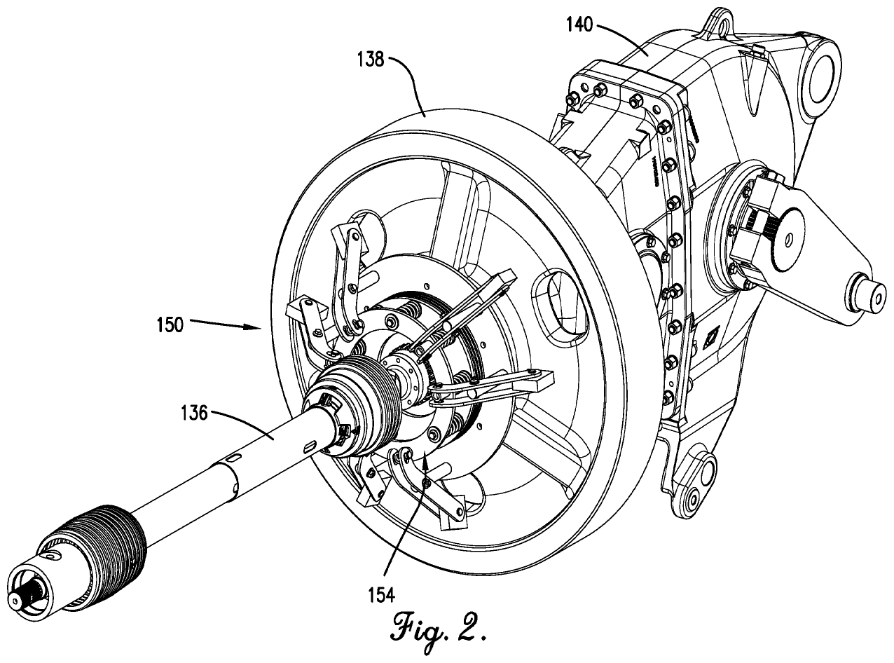

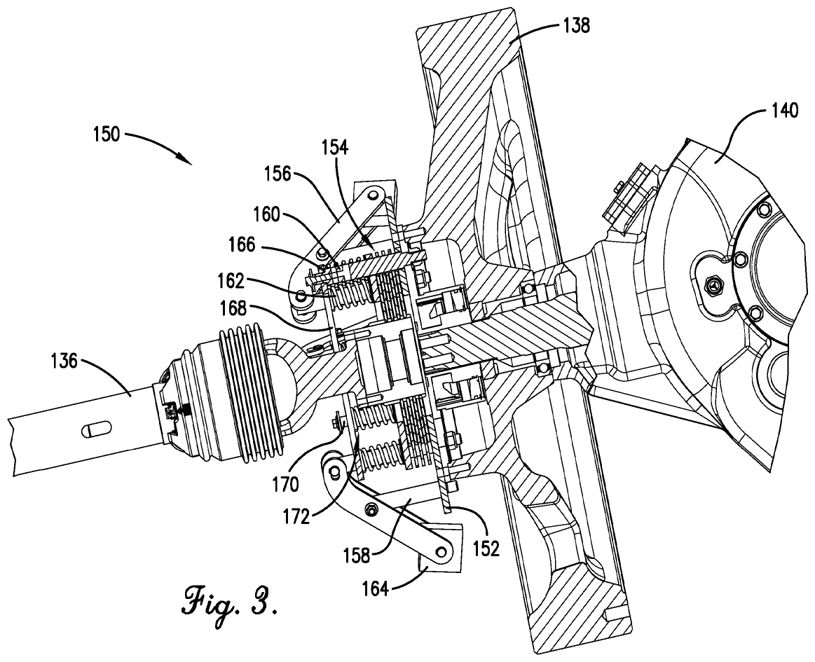

In a first embodiment of the present invention, an integrated driveline slip clutch system 150 may use centrifugal force to move a slip clutch between a disengaged and one or more engaged relationships. Referring to FIGS. 2 and 3, the clutch system 150 may facilitate transferring power from the driveline 136 to the flywheel 138 and the gearbox 140, wherein the driveline 136, flywheel 138, and gearbox 140 may be otherwise substantially conventional. The clutch system 150 may broadly comprise a flywheel mounting plate 152, a slip clutch 154 including a plurality of clutch plates, a plurality of lever arms 156, a plurality of pivot support pins 158, a plurality of spring support pins 160, a plurality of springs 162, and a plurality of weights 164. The flywheel mounting plate 152 may be part of or attached to the flywheel 138 and rotate therewith. The slip clutch 154 may be moveable between a disengaged relationship with the flywheel 138, in which case no power is transferred from the driveline 136, and one or more engaged relationships with the flywheel 138, in each of which an amount of power is transferred from the driveline 136.

The plurality of lever arms 156 may be arranged in a spaced-apart relationship around a perimeter of the flywheel mounting plate 152. Each lever arm 156 may present a first end, a second end, and an intermediate portion between the first and second ends. Each pivot support pin 158 may present a first end and a second end, wherein the first end of the pivot support pin 158 may be pivotably attached to the intermediate portion of a respective lever arm 156, and the second end of the pivot support pin 158 may be fixedly attached to the flywheel mounting plate 152. Each spring support pin 160 may present a first end, a body, and a second end, wherein the first end of the spring support pin 160 may be slidably associated with the first end of a respective lever arm 156 and may present a shoulder stop 166 configured to limit the inward sliding movement of the lever arm 156 on the spring support pin 160, the body of the spring support pin 160 may extend through the clutch plates of the slip clutch 154, and the second end of the spring support pin 160 may be attached to the flywheel mounting plate 152. The plurality of springs 162 may be configured to provide the appropriate force for proper clutch frictional torque. Each spring 162 may present a first end and a second end, wherein the first end of the spring 162 abuts the first end of a respective lever arm 156 and the second end of the spring 162 abuts the slip clutch 154. Each weight 164 may be pivotably or otherwise mounted to the second end of a respective lever arm 156.

The clutch system 150 may further include an outer ring 168 configured to facilitate maintaining proper alignment of other components and to better distribute forces applied via the lever arms 156. The clutch system 150 may also further include one or more additional spring support pins 170 and associated springs 172 that are not connected to lever arms 156, wherein the outer ring 168 transmits the force applied by adjacent lever arms 156 to these additional pins 170 and springs 172.

In operation, the springs 162 may be partially relaxed (or decompressed) before the PTO 32 is engaged so that at startup the slip clutch 154 slips freely with little torque transmitted. As the PTO 32 is engaged, the tractor/driveline RPMs increase, and the driveline/flywheel speed increases, centrifugal force causes the weights 164 to move radially outward. The weights 164 act on the lever arms 156 which pivot on the pivot support pins 158 attached to the flywheel mounting plate 152, so that as the weights 164 move outward, force is applied to the springs 162 through the lever arms 156. The desired torque setting is maintained as the spring force is controlled when the lever arms 156 contact the shoulders 166 of the spring support pins 160, thereby stopping inward movement of the lever arms and limiting the amount of force applied to the springs 162 and, via the springs 162, to the slip clutch 154. Thus, the centrifugal force, acting through the weights 164 and the lever arms 156, and controlled by the springs 162, may move the slip clutch 154 into the one or more engaged relationships.

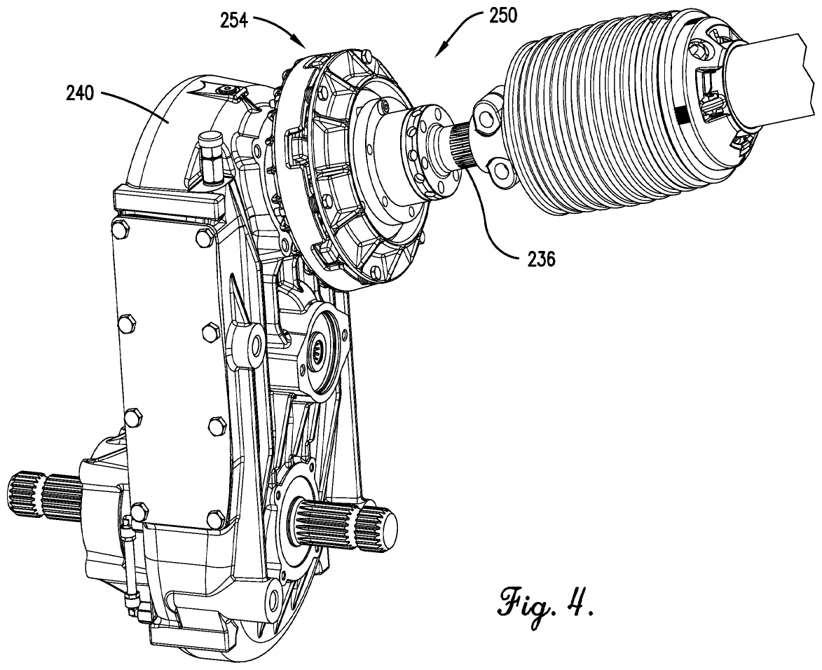

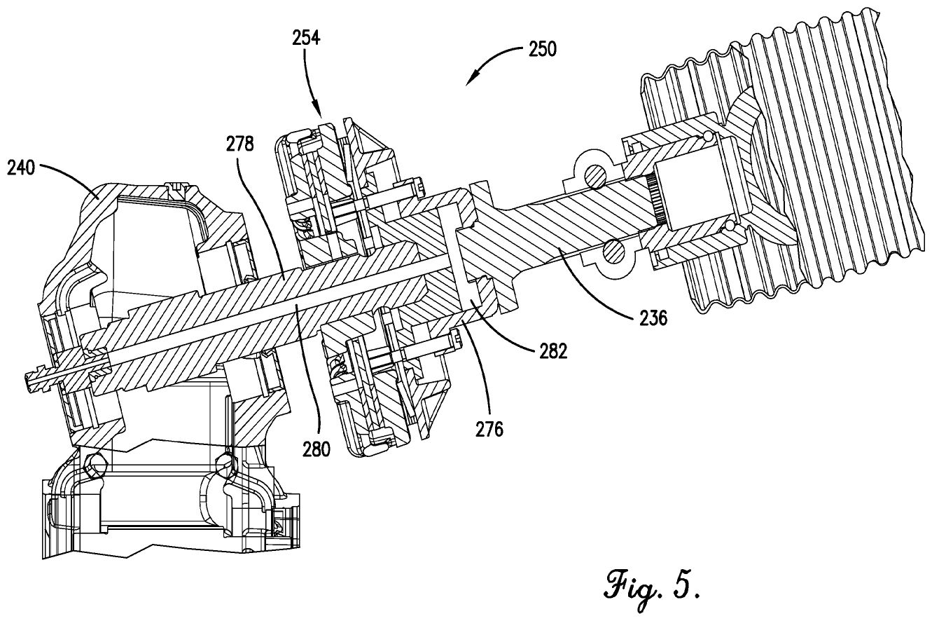

In a second embodiment, the integrated driveline slip clutch system 250 may be relocated to be near or at the front of the frame 34 of the baler 28 by the gearbox 240, and may use a clutch cylinder to move a clutch between a disengaged and one or more engaged relationships. This clutch system 250 may be used only at startup, rather than providing both dual purpose engaged and slip protection. Referring to FIGS. 4 and 5, the clutch system 250 may facilitate transferring power from the driveline 236 to the gearbox 240, wherein the driveline 236 and gearbox 240 may be otherwise substantially conventional. The clutch system 250 may broadly comprise a clutch cylinder 276, a clutch 254, and a gearbox shaft 278 having a central passage 280. The clutch cylinder 276 may be attached to the driveline 236, and may present an interior cavity 282. The clutch 254 may be otherwise substantially conventional, and may include a plurality of clutch plates, and a plurality of springs for controlling friction torque. The gearbox shaft 278 may be attached to the gearbox 240 and extend through a center of the clutch 254 to be in fluid communication with the interior cavity 282 of the clutch cylinder 276.

In operation, pressurized oil or other hydraulic fluid may be introduced through the central passage 280 into the interior cavity 282 of the clutch cylinder 276 to force the clutch cylinder 276 away from the clutch 254 and thereby disengage the clutch 254 from the driveline 236.

The hydraulic fluid may then be removed from the interior cavity 282 via the central passage 280 to allow the clutch cylinder 276 to move back into contact with the clutch 254 and thereby engage the clutch 254 with the driveline 236. Thus, the hydraulic fluid, acting on the clutch cylinder 276, may move the slip clutch 254 into the one or more engaged relationships.

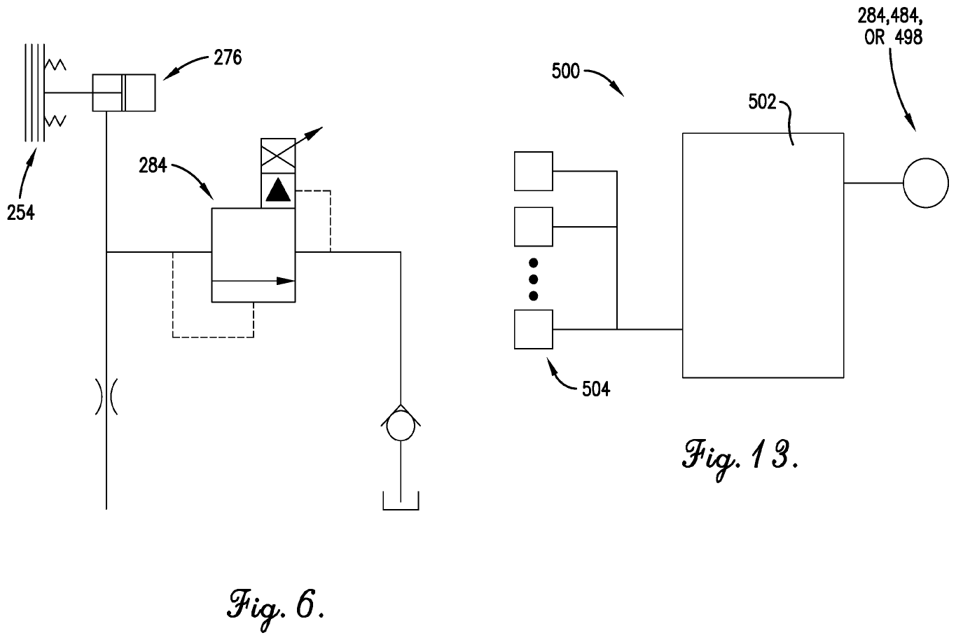

Referring also to FIG. 6, in one implementation the hydraulic fluid may be stored in and transferred from and to a reservoir tank (located on, e.g., the tractor 26), and introduction and removal of the hydraulic fluid may be controlled, at least in part, by a pressure release device (PRD) valve 284 interposed between the reservoir tank and the central passage 280 through the gearbox shaft 278. In operation, the clutch 254 may be released before starting the baler 28 by applying full pulse-width modulated (PWM) power to a solenoid coil of the PRD valve 284 and transferring hydraulic fluid from the reservoir tank to the interior cavity 282 of the clutch cylinder 276, thereby disengaging the clutch 254. Then, controlled baler startup may be initiated by reducing PWM power to the solenoid coil of the PRD valve 284 at a controlled rated to remove the hydraulic fluid from the interior cavity 282 and transfer it back to the reservoir tank, thereby engaging the spring-applied clutch plates of the clutch 254.

In various implementations, introduction and removal of the hydraulic to disengage and engage the clutch may be controlled by a mechanical or electronic control mechanism, such as the electronic control system 500 shown in FIG. 13 and described below.

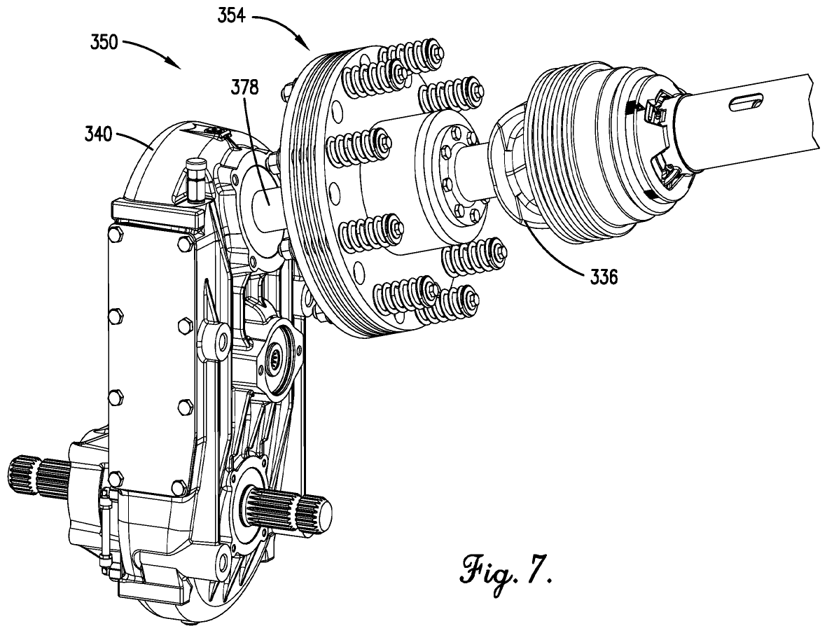

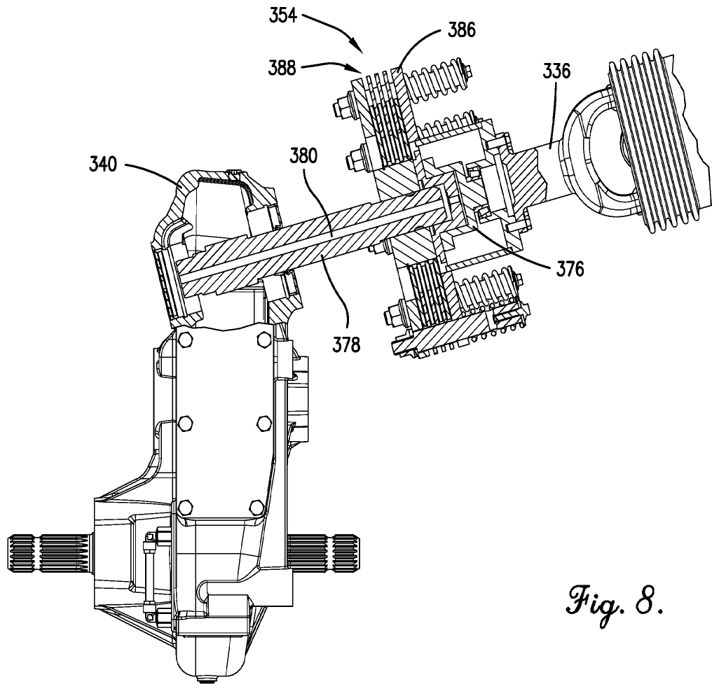

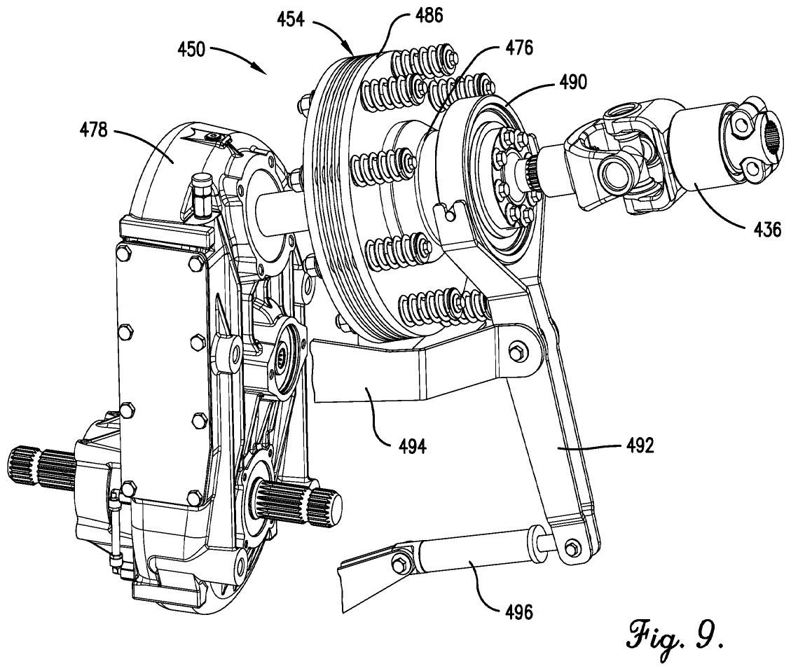

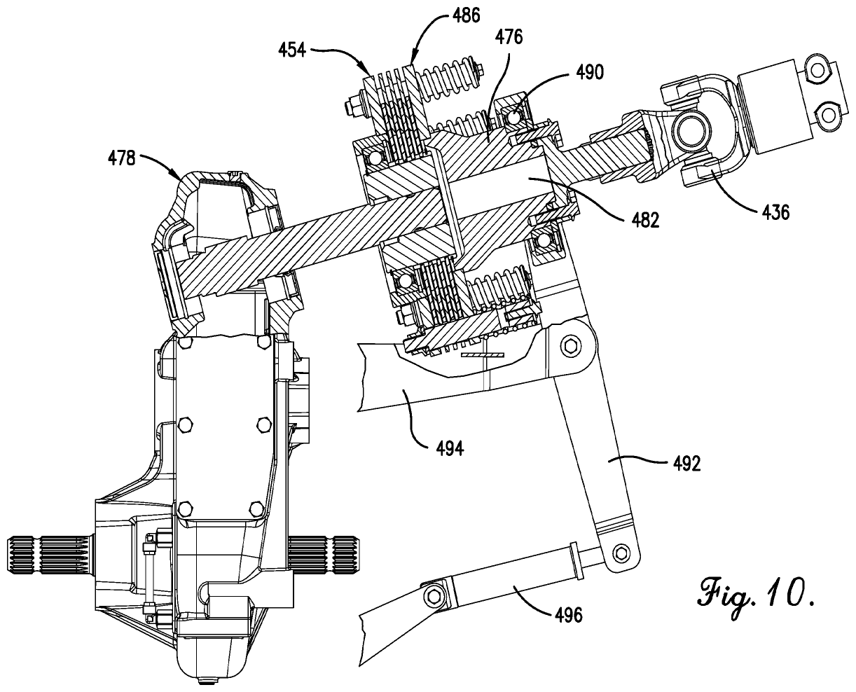

In a third embodiment, the integrated driveline slip clutch system 350 may again be relocated to be near or at the front of the frame 34 of the baler 28 by the gearbox 340, and may again use a clutch cylinder 376 to actuate in response to hydraulic fluid being introduced and removed through a central passage 380 through a gearbox shaft 378. However, this design may provide both protection against driveline slip and controlled engagement at baler startup. Referring to FIGS. 7 and 8, the clutch system 350 may facilitate transferring power from the driveline 336 to the gearbox 340, wherein the driveline 336 and gearbox 340 may be otherwise substantially conventional. The clutch system 350 may broadly comprise the clutch cylinder 376, the slip clutch 354, and the gearbox shaft 378 having the central passage 380.

In operation, the springs that control friction torque are also compressed by the clutch cylinder 376 pulling a rear outside pressure plate 386 away from the clutch friction surface plates 388. This opens the clutch plates 388 to allow the slip clutch 354 to slip freely. Thus, here again, the hydraulic fluid, acting on the clutch cylinder 376, may move the slip clutch 354 into the one or more engaged relationships.

In various implementations, introduction and removal of the hydraulic fluid to disengage and engage the slip clutch may be controlled by a mechanical or electronic control mechanism, such as the electronic control system 500 shown in FIG. 13 and described below.

In a fourth embodiment, the integrated driveline clutch system 450 may be similar to that of the third embodiment but may use a double acting external control cylinder to move a slip clutch between a disengaged and one or more engaged relationships. This advantageously allows additional force to be applied to the friction clutch plates to increase the available starting torque, which may be required, for example, during hard startups of the baler 28 after a blockage. In this design, the slip clutch 454 may or may not be mounted to a flywheel.

Referring to FIGS. 7 and 8, the clutch system 450 may facilitate transferring power from the driveline 436 to the gearbox 440, wherein the driveline 436 and gearbox 440 may be otherwise substantially conventional. The clutch system 450 may broadly comprise the clutch cylinder 476, a yoke 490, a lever arm 492, a pivot arm 494, a double acting cylinder 496, and the slip clutch 454. The yoke 490 may be attached to the clutch cylinder 476. The lever arm 492 may present a first end, a second end, and an intermediate portion, wherein the first end may be attached to the yolk 490, the second end may be attached to the double acting cylinder 496, and the intermediate portion may be pivotably attached to the pivot arm 494. The double acting cylinder 496 may be extensible and retractable to actuate the lever arm 492, and may present a first end and a second end, wherein the first end of the double acting cylinder 496 may be attached to the second end of the lever arm 492, the second end may be fixedly attached to framework, and the intermediate portion of the lever arm 492 may be pivotably attached to the pivot arm 494. The slip clutch 454 may be otherwise substantially conventional, and may include a plurality of clutch plates, and a plurality of springs for controlling friction torque.

In operation, extension and retraction of the double acting cylinder 496 may be transmitted via the lever arm 492 and yolk 490 to the clutch cylinder 476 to, respectively, engage and disengage the slip clutch 454. The clutch cylinder 476 may be connected by a release bearing attached to the outer clutch pressure plate 486. The clutch cylinder 476 may relax after the baler 28 has started and the flywheel is at operating speed. The clutch slip torque may again be controlled by the predetermined length of the compression spring pushing on the pressure plate 486. Thus, here again, the hydraulic fluid, acting on the clutch cylinder 376, may move the slip clutch 354 into the one or more engaged relationships.

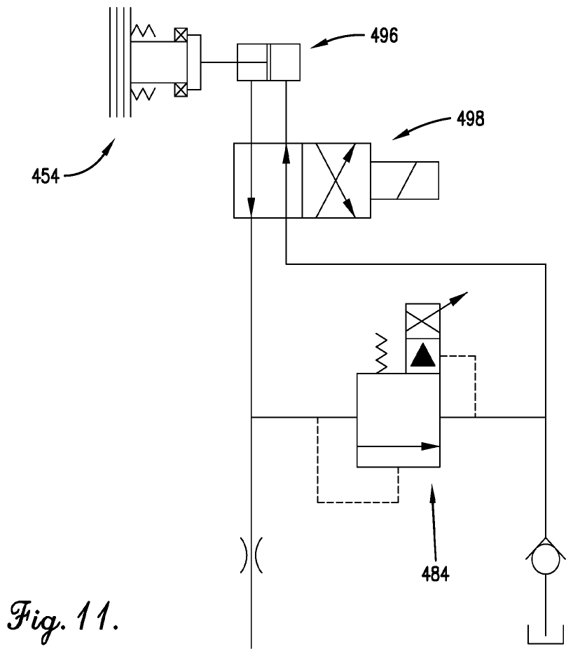

Referring also to FIG. 11, in one implementation the hydraulic fluid may be stored in and transferred from and to the reservoir tank, and introduction and removal of the hydraulic fluid may be controlled, at least in part, by a PRD valve 484 interposed between the reservoir tank and the double acting cylinder 496. In operation, the slip clutch 454 may be released before starting the baler 28 by applying full PWM power to the solenoid coil of the PRD valve 484 and transferring fluid from the reservoir tank to a first side of the double acting cylinder 496, thereby disengaging the slip clutch 454. Then, controlled baler startup may be initiated by reducing PWM power to the solenoid coil of the PRD valve 484 at a controlled rate to remove the fluid from the first side of the double acting cylinder 496 and transfer it back to the reservoir tank, thereby engaging the spring-applied clutch plates. Introduction and removal of the hydraulic fluid may be further controlled, at least in part, by a solenoid actuated gate valve 498 (e.g., a DGS4A valve) interposed between the reservoir tank and the double acting valve 484, and configured to direct the fluid flow to the other side of the double acting cylinder 496. Doing this may increase the clutch torque beyond the normal spring setting to provide additional force to the baler plunger 42 and other components for hard and plugged baler startups.

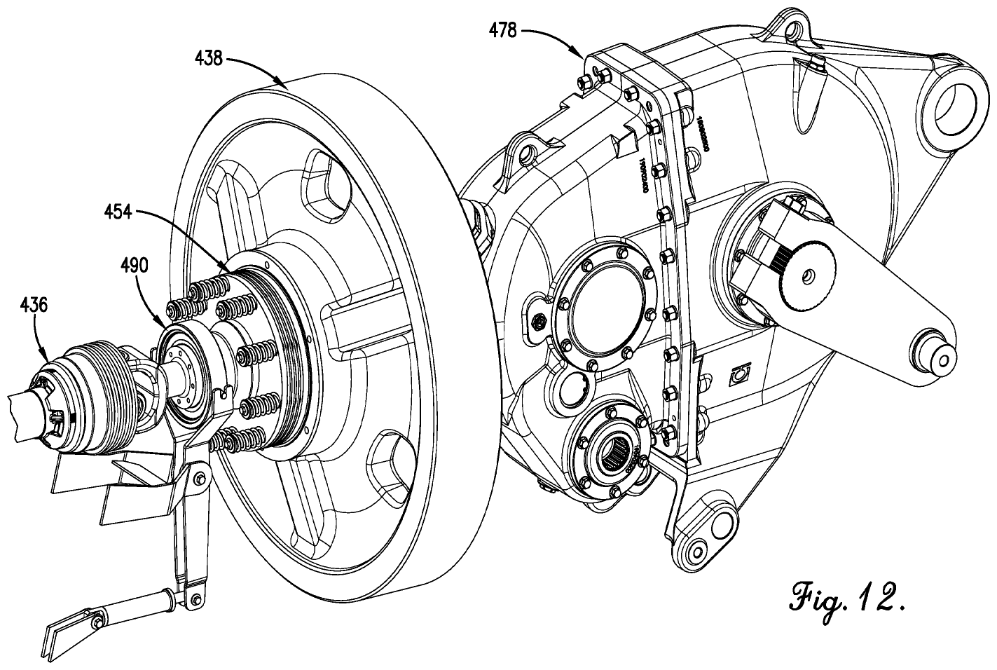

Referring also to FIG. 12, the slip clutch 454 of the fourth embodiment is shown alternatively mounted to the flywheel 438, but may be otherwise substantially similar or identical in operation.

In various implementations, introduction and removal of the hydraulic fluid to disengage and engage the clutch may be controlled by a mechanical or electronic control mechanism, such as the electronic control system 500 shown in FIG. 13 and described below.

Referring to FIG. 13, an exemplary embodiment of an electronic control system 500 for use in controlling operation of the second, third, and fourth embodiments of the driveline engagement slip clutch system 250,350,450 may broadly comprise an electronic controller 502 configured to receive input data signals from one or more sensors 504 and transmit control output signals to components of the clutch system 250,350,450. This control functionality may be implemented on a dedicated electronic controller or on an existing electronic controller which is further configured to perform one or more other functions related to operation of the baler 28. The electronic controller 502 may evaluate input data signals from several existing baler sensors 504, such as speed and position sensors. Based on such sensor data, the electronic controller 502 may control the valves 284,484,498 used in the second, third, and fourth embodiments to introduce and remove the hydraulic fluid. In one implementation, the electronic controller 502 may further receive input data signals regarding, e.g., engine speed and PTO engagement, from the tractor 26 via a controller area network (CAN) bus between the tractor 26 and the baler 28, and may use this additional data in determining how to control engagement of the slip clutch 254,354,454.

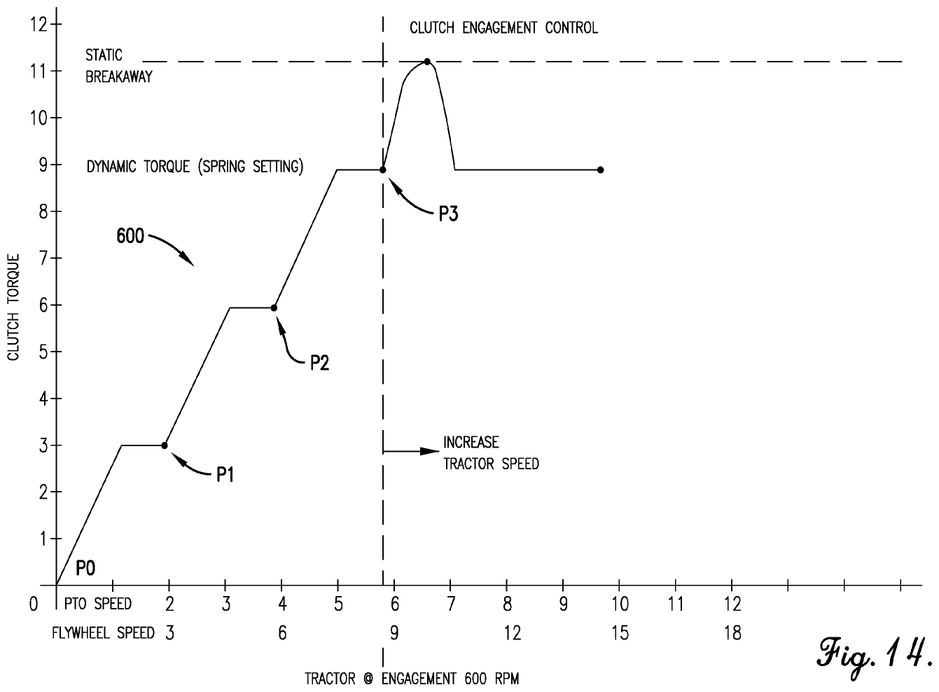

Referring also to FIG. 14, an exemplary clutch engagement pressure control profile 600 is shown wherein the clutch system is in one or more engaged relationships, and in each engaged relationship an amount of power is being transferred from the driveline to the gearbox. The different engagement relationships may result from different pressures of the hydraulic fluid. Thus, this profile may be followed by the electronic controller 502. At an initial pressure, PO, PTO speed, flywheel speed, and clutch torque may all be zero. The electronic controller 502 may increase clutch engagement at a controlled rate by ramping hydraulic fluid pressure to a first pressure, P1, then ramping hydraulic fluid pressure to a second pressure, P2, and then ramping hydraulic fluid pressure to a final pressure, P3. At P3, the spring setting determines full clutch engagement, and tractor speed can be increased.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A baler powered by a tractor, the baler comprising:
a plunger reciprocal within a baling chamber;
a driveline configured to receive mechanical power from the tractor;
a flywheel configured to smooth the received mechanical power;
a gearbox configured to condition the smoothed mechanical power to drive the reciprocating plunger; and
an integrated driveline clutch system for controlling a transfer of power from the tractor to the integrated driveline clutch system including a slip clutch having a plurality of clutch plates, wherein the slip clutch is configured to be moveable between a disengaged relationship in which no power is transferred from the driveline to the gearbox, and one or more engaged relationships in each of which an amount of power is transferred from the driveline to the gearbox.

2. The baler as set forth in claim 1, wherein movement of the slip clutch between the disengaged relationship and the one or more engaged relationships is controlled mechanically.

3. The baler as set forth in claim 2, wherein movement of the slip clutch between the disengaged relationship and the one or more engaged relationships is controlled by a plurality of weights attached to a plurality of lever arms spaced around a perimeter of the plurality of clutch plates, and wherein a centrifugal force provided by a turning of the driveshaft causes the plurality of weights to apply via the plurality of lever arms a compressive force to the plurality of clutch plates and thereby move the slip clutch into the one or more engaged relationships.

4. The baler as set forth in claim 3, the slip clutch further including a plurality of springs interposed between the plurality of lever arms and the plurality of clutch plates, and configured to control the compressive force applied by the plurality of lever arms to the plurality of clutch plates.

5. The baler as set forth in claim 1, wherein movement of the slip clutch between the disengaged relationship and the one or more engaged relationships is controlled electronically.

6. The baler as set forth in claim 5, wherein movement of the slip clutch between the disengaged relationship and the one or more engaged relationships is controlled by an electronically controlled valve configured to introduce and remove a hydraulic fluid so as to move a clutch cylinder to act on the plurality of clutch plates and thereby move the slip clutch into the one or more engaged relationships.

7. The baler as set forth in claim 6, the integrated driveline clutch system further including an electronic controller configured to receive one or more input data signals from one or more sensors concerning operation of the baler, and based on the one or more input data signals, control operation of the electronically controlled valve.

8. The baler as set forth in claim 7, wherein the electronic controller is configured to cause the electronically controlled valve to introduce and remove the hydraulic fluid at a controlled rate to achieve the one or more engaged relationships.

9. The baler as set forth in claim 8, wherein the electronic controller is configured to follow a pressure control profile in which the electronic controller causes the amount of hydraulic to be ramped at the controlled rate through one or more levels to achieve the one or more engaged relationships.

10. The baler as set forth in claim 6, the slip clutch further including a plurality of springs interposed between the clutch cylinder and the plurality of clutch plates, and configured to control the compressive force applied by the clutch cylinder to the plurality of clutch plates.

11. The baler as set forth in claim 6, further including a gearbox shaft having a central passage in fluid communication with the clutch cylinder, wherein the hydraulic fluid is introduced into and removed from the clutch cylinder via the central passage in the gearbox shaft.

12. The baler as set forth in claim 6, further including a double acting cylinder configured to move the clutch cylinder, wherein introduction of the hydraulic fluid into the double acting cylinder moves the clutch cylinder to apply a compressive force to the plurality of clutch plates and thereby move the slip clutch into the one or more engaged relationships.

13. The baler as set forth in claim 12, further including a lever arm attached at a first end by a yoke to the clutch cylinder, and attached at a second end to the double acting cylinder, and configured to transmit movement of the double acting cylinder via the yoke to the clutch cylinder.

14. A baler powered by a tractor, the baler comprising:
a plunger reciprocal within a baling chamber;
a driveline configured to receive mechanical power from the tractor;
a flywheel configured to smooth the received mechanical power;
a gearbox configured to condition the smoothed mechanical power to drive the reciprocating plunger; and
an integrated driveline clutch system for controlling a transfer of power from the tractor to the integrated driveline clutch system including
a slip clutch having a plurality of clutch plates, and configured to be moveable between a disengaged relationship in which no power is transferred from the driveline to the gearbox, and one or more engaged relationships in which in each engaged relationship an amount of power is transferred from the driveline to the gearbox, and
a plurality of weights attached to a plurality of lever arms spaced around a perimeter of the plurality of clutch plates, wherein a centrifugal force provided by a turning of the driveshaft causes the plurality of weights to apply via the plurality of lever arms a compressive force to the plurality of clutch plates and thereby move the slip clutch into the one or more engaged relationships.

15. The baler as set forth in claim 14, the slip clutch further including a plurality of springs interposed between the plurality of lever arms and the plurality of clutch plates, and configured to control the compressive force applied by the plurality of lever arms to the plurality of clutch plates.

16. A baler powered by a tractor, the baler comprising:
a plunger reciprocal within a baling chamber;
a driveline configured to receive mechanical power from the tractor;
a flywheel configured to smooth the received mechanical power;
a gearbox configured to condition the smoothed mechanical power to drive the reciprocating plunger; and
an integrated driveline clutch system for controlling a transfer of power from the tractor to the, the integrated driveline clutch system including
a slip clutch having a plurality of clutch plates, and configured to be moveable between a disengaged relationship in which no power is transferred from the driveline to the gearbox, and one or more engaged relationships in which in each engaged relationship an amount of power is transferred from the driveline to the gearbox,
an electronically controlled valve configured to introduce and remove a hydraulic fluid so as to move a clutch cylinder to act on the plurality of clutch plates and thereby move the slip clutch into the one or more engaged relationships, and
an electronic controller configured to receive one or more input data signals from one or more sensors concerning operation of the baler, and based on the one or more input data signals, control operation of the electronically controlled valve.

17. The baler as set forth in claim 16, wherein the electronic controller is configured to control introduction and removal of the hydraulic fluid so as to move a clutch cylinder to act on the plurality of clutch plates and thereby move the slip clutch into the one or more engaged relationships.

18. The baler as set forth in claim 16, the slip clutch further including a plurality of springs interposed between the clutch cylinder and the plurality of clutch plates, and configured to control the compressive force applied by the clutch cylinder to the plurality of clutch plates.

19. The baler as set forth in claim 16, further including a gearbox shaft having a central passage in fluid communication with the clutch cylinder, wherein the hydraulic fluid is introduced and removed by the electronically controlled valve via the central passage in the gearbox shaft.

20. The baler as set forth in claim 16, further including
a double acting cylinder; and
a lever arm attached at a first end by a yoke to the clutch cylinder, and attached at a second end to the double acting cylinder, wherein introduction of the hydraulic fluid into the double acting cylinder results in movement of the double acting cylinder which is transmitted via the lever arm and yoke to the clutch cylinder to act on the plurality of clutch plates and thereby move the slip clutch into the one or more engaged relationships.
